(19) United States
(12) Patent Application Publication
(10) Pub. No.: US 2001/0006934 A1
(43) Pub. Date: Jul. 5, 2001

(54) Catalytic converter with multilayered catalyst system

(75) Inventors: Naoki Kachi, Yokohama (JP); Kimiyoshi Nishizawa, Yokohama (JP)

Correspondence Address: FOLEY & LARDNER, Washington Harbour, 3000 K Street, N.W., Suite 500, P.O. Box 25696, Washington, DC, 20007-8696, US

(73) Assignee: NISSAN MOTOR CO., LTD.

(21) Appl. No.: 09/742,428

(22) Filed: Dec. 22, 2000

(30) Foreign Application Priority Data
Dec. 27, 1999 (JP) 11-370145

(51) Int. Cl. B01J 23/00; B01J 23/56; B01J 23/44; B01J 23/42; B01D 50/00; B01D 53/34

(52) U.S. Cl. 502/325; 502/332; 502/333; 502/334; 502/339; 502/527.12; 502/527.13; 422/177

(57) ABSTRACT

A catalytic converter including a carrier, a hydrocarbon (HC) trap layer disposed on the carrier and at least two catalyst layers comprising an inner layer disposed on the HC trap layer and an outer layer disposed on the inner layer. The inner and outer layers include catalyst noble metals, respectively. The catalyst noble metal present in the outer layer is controlled to be active earlier than the catalyst noble metal present in the inner layer during the engine warm-up operation.

### FIELD OF THE INVENTION

This invention relates to a catalytic converter useable for purification of exhaust gas emitted from a vehicle engine and, more particularly, to an improved catalytic converter including a multilayered catalyst system disposed on a hydrocarbon (HC) trap layer.

### BACKGROUND OF THE INVENTION

There has been proposed a catalytic converter having a multilayered structure in which a HC trap layer and an oxidation catalyst layer or three-way catalyst layer are arranged on a carrier as a catalyst carrier. Catalytic converters of such a multilayered type are disclosed in Japanese Patent Application First Publication No. 7-96183 and European Patent Application Publication No. 0716877 A1.

The HC trap layer of the catalytic converter temporarily traps unburnt HC present in the exhaust gas emitted from the engine during the cold operation. The catalytic activity of the catalyst present in the catalyst layer is low upon the engine cold operation. When the engine comes into a warm-up condition and the catalytic converter is sufficiently heated, the HC trapped in the HC trap layer is released therefrom and oxidized in the catalyst layer disposed on the HC trap layer.

### SUMMARY OF THE INVENTION

In general, the temperature at which HC is released from the HC trap layer is lower than the temperature at which the catalyst starts to show its activity. Hence, there is such a problem that a part of the HC released from the HC trap layer is discharged without being oxidized before the catalyst reaches the fully activated state.

An object of the present invention is to provide a catalytic converter capable of promoting temperature rise at the catalyst layer surface exposed to the exhaust gas to early activate the catalyst present in the catalyst layer, then improving purification of the HC released from the HC trap layer.

According to one aspect of the present invention, there is provided a catalytic converter, comprising:

a carrier;

a hydrocarbon (HC) trap layer trapping HC, said HC trap layer being disposed on the carrier; and

at least two catalyst layers comprising an inner layer disposed on the HC trap layer and an outer layer disposed on the inner layer, said inner and outer layers comprising catalyst noble metals,

an amount of said catalyst noble metal present in the outer layer based on a unit volume of the carrier being larger than an amount of the catalyst noble metal present in the inner layer based on the unit volume of the carrier.

According to a further aspect of the present invention, there is provided a catalytic converter, comprising:

a hydrocarbon (HC) trap layer trapping HC; and

at least two catalyst layers comprising an inner layer disposed on the HC trap layer and an outer layer disposed on the inner layer, each of said inner and outer layers comprising a catalyst noble metal and a washcoat,

a mass ratio of said catalyst noble metal present in the outer layer to the washcoat present therein being higher than a mass ratio of the catalyst noble metal present in the inner layer to the washcoat present therein.

According to a still further aspect of the present invention, there is provided a catalytic converter, comprising:

a carrier;

a hydrocarbon (HC) trap layer trapping HC, said HC trap layer being disposed on the carrier; and

at least two catalyst layers comprising an inner layer disposed on the HC trap layer and an outer layer disposed on the inner layer, each of said inner and outer layers comprising a catalyst noble metal and a washcoat,

an amount of said washcoat present in the outer layer based on a unit volume of the carrier being smaller than an amount of the washcoat present in the inner layer based on the unit volume of the carrier.

According to a still further aspect of the present invention, there is provided a catalytic converter, comprising:

a carrier;

a hydrocarbon (HC) trap layer trapping HC, said HC trap layer being disposed on the carrier; and

a multilayered catalyst system disposed on the HC trap layer, said multilayered catalyst system comprising a first catalyst layer disposed on the HC trap layer and a second catalyst layer disposed on the first catalyst layer, said first and second catalyst layers comprising catalyst noble metals, respectively, said catalyst noble metal present in the second catalyst layer being controlled to be active earlier than the catalyst noble metal present in the first catalyst layer.

### BRIEF DESCRIPTION OF THE DRAWINGS

FIG. 1 is a sectional view of an important part of a catalytic converter of a first embodiment of the present invention;

FIG. 2 illustrates characteristic curves of Example 1 and Comparative Example 1;

FIG. 3 is a graphic illustration of HC purification rates in Example 1 and Comparative Example 1; and

FIG. 4 is a view similar to FIG. 1, but showing a second embodiment of the invention.

### BEST MODE FOR CARRYING OUT THE INVENTION

A catalytic converter according to the present invention includes a carrier, a hydrocarbon (HC) trap layer trapping HC and disposed on the carrier, and a multilayered catalyst system disposed on the HC trap layer. The catalyst system includes at least two catalyst layers including an inner layer disposed on the HC trap layer and an outer layer disposed on the inner layer to be exposed to an exhaust gas emitted from an engine. The inner and outer layers include catalyst noble metals, respectively. An amount (weight) of the catalyst noble metal present in the outer layer based on a unit volume of the carrier is larger than that of the catalyst noble metal present in the inner layer based on the unit volume of the carrier. Here, the volume of the carrier includes a space surrounding the carrier on which activity of the catalysts to be supported on the carrier is exerted, i.e. the space through which an exhaust gas emitted from an engine passes for treatment by the catalysts. As the amount of the catalyst noble metal present in the catalyst layer exposed to the exhaust gas increases, the temperature at the catalyst layer quickly rises so that the catalyst noble metal in the catalyst layer can be early active in HC conversion. Therefore, the larger amount of the catalyst noble metal present in the outer layer as explained above can be early activated during the engine warm-up operation. The catalysts in the outer and inner layers then can purify the HC released from the HC trap layer at a high rate during the catalyst activation period. The large distribution of the catalyst noble metal in the outer layer also can limit the total amounts of the expensive catalyst noble metals to be used in the catalyst system to a low level, then serving for cost-saving.

The catalyst noble metal may include rhodium (Rh), wherein an amount of the Rh present in the catalyst layer can be calculated as a value obtained by multiplying the amount of the Rh by a predetermined number. This is because Rh has higher three-way catalytic activity than those of other catalyst noble metals such as platinum (Pt) and palladium (Pd), and therefore an amount of the Rh used in the catalyst layer can be reduced as compared those of other catalyst noble metals. The reduction of the amount of the Rh will contribute to the cost-saving. The predetermined number may be defined depending on the kind of the catalyst noble metals other than Rh. For instance, if the catalyst noble metal other than Rh is Pd, the predetermined number may be about ten. The catalyst layer including Rh may be the outer-most layer of the catalyst system.

Each of the inner and outer layers includes a washcoat. A mass ratio of the catalyst noble metal present in the outer layer to the washcoat present therein is higher than a mass ratio of the catalyst noble metal present in the inner layer to the washcoat present therein. Similar to the above-explained case in which the larger amount of the catalyst noble metal based on the unit volume of the carrier is present in the outer layer, as the mass ratio of the catalyst noble metal present in the catalyst layer exposed to the exhaust gas increases, the temperature at the catalyst layer quickly rises and the catalyst noble metal in the catalyst layer can be early active in HC conversion. Therefore, the catalyst noble metal present in the outer layer at the higher mass ratio can be early activated during the engine warm-up operation. The HC released from the HC trap layer can be purified by the catalyst noble metals in the outer and inner layers at a high rate during the catalyst activation period. The higher mass ratio of the catalyst noble metal present in the outer layer also serves for reduction of the whole amount of the expensive catalyst noble metal to be used in the catalyst system, and then for cost-saving.

The mass ratio of the catalyst noble metal present in the outer layer as an outer-most layer and to the washcoat present therein may be five times or more the mass ratio of the catalyst noble metal present in the inner layer disposed below the outer-most layer, to the washcoat present therein.

Further, the amount of the washcoat present in the outer layer based on the unit volume of the carrier is smaller than the amount of the washcoat present in the inner layer based on the unit volume of the carrier. This can reduce the heat capacity of the outer layer to thereby cause quick temperature rise at the outer layer during the catalyst activation period, serving for further increasing the HC conversion efficiency of the catalyst system.

The outer-most layer may include palladium (Pd) and the inner layer below the outer-most layer may include a combination selected from Pd, Pt and Rh. Since Pd has the excellent catalytic activity at a relatively low temperature, the catalytic converter including the outer-most layer including Pd and the inner layer including the combination selected from Pd, Pt and Rh can exhibit high HC conversion efficiency at a relatively low temperature as well as a stable performance relative to variation in air-fuel ratio.

Further, each of the inner and outer layers may include a promoter (co-catalyst) such as cerium (Ce) and barium (Ba). Ce has a good oxygen storage ability and Ba has the promotion property of enhancing catalytic conversion efficiency. In the case of using the promoter, an amount of the promoter present in the outer layer based on the unit volume of the carrier may be smaller than an amount of the promoter present in the inner layer based on the unit volume of the carrier. This can decrease a specific heat of the outer layer to thereby enhance the HC conversion efficiency during the catalyst activation period.

Furthermore, the catalytic converter of the present invention may include a base coat layer disposed between the carrier and the HC trap layer, wherein the base coat layer may include alumina or silica as a main component. This can reduce a thickness of the corner portion of the HC trap layer which is located on a corner portion of the carrier, such as a corner portion of a cell of a honeycomb-shaped carrier. The corner portion of the HC trap layer has a thickness larger than that of the wall portion thereof connected with the corner portion, as explained later. The inner side of the corner portion located on a surface of the corner portion of the cell of the carrier has less influence on the HC trapping efficiency and therefore it does not directly contribute to enhancement of the HC trapping efficiency. With the arrangement of the base coat layer, an amount of an expensive material used for the HC trap layer can be reduced.

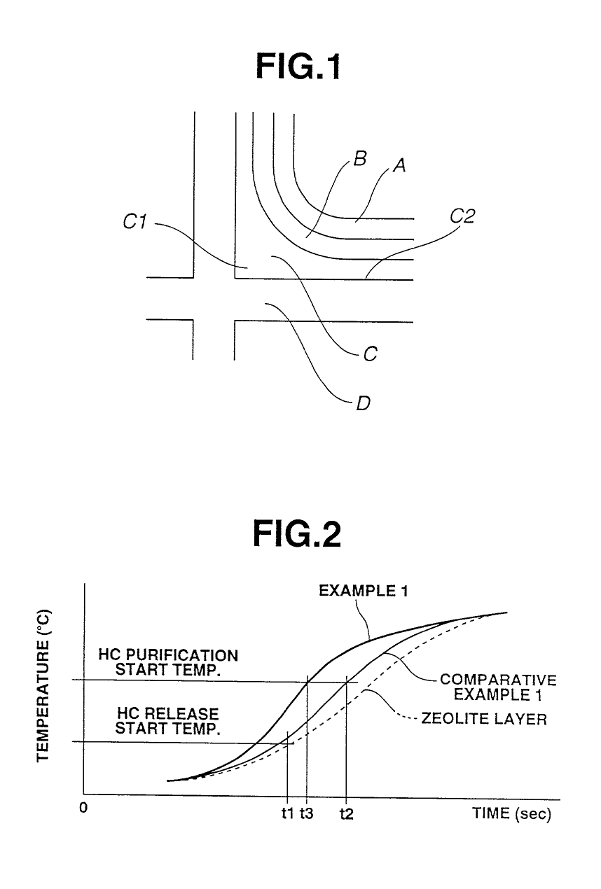

Referring now to FIG. 1, the catalytic converter of a first embodiment, according to the present invention, is explained.

As illustrated in FIG. 1, the catalytic converter includes carrier D and a three-layered structure on carrier D. The three-layered structure includes HC trap layer C and a dual-layered catalyst system which includes inner catalyst layer B disposed on HC trap layer C and outer catalyst layer A disposed on inner catalyst layer B. Carrier D is a ceramic honeycomb-shaped carrier defining cells that have spaces through which an exhaust gas emitted from an engine passes. Carrier D may be a metal-laminated carrier. HC trap layer C disposed on carrier D includes zeolite. Outer and inner catalyst layers A and B are three-way catalyst layers including catalyst noble metals such as Pd, Rh and Pt. Outer catalyst layer A, inner catalyst layer B and HC trap layer C include washcoats, and outer and inner catalyst layers A and B may optionally include promoters (co-catalysts).

FIG. 4 illustrates a second embodiment of the catalytic converter of the invention, which differs from the above-described first embodiment in arrangement of base coat layer E between HC trap layer C and carrier D.

As illustrated in FIG. 4, base coat layer E is applied onto carrier D, onto which HC trap layer C is then applied. Base coat layer E may include alumina or silica as a main component. Base coat layer E is thickened at a corner of the cell of carrier D. With the arrangement of base coat layer E, a curved corner portion of HC trap layer C, which is disposed on the thickened portion of base coat layer E, can have a reduced thickness as compared with corner portion Cl of HC trap layer C as shown in FIG. 1. In a case where HC trap layer C is directly applied onto carrier D as illustrated in FIG. 1, the thickness of HC trap layer C tends to be greater at corner portion C1 located on the corner of the cell of carrier D than at general portion C2. An inner portion of corner portion C1 which is disposed immediately adjacent to a surface of carrier D, has less influence on HC trapping efficiency. Accordingly, owing to the application of base coat layer E, an amount of an expensive material such as zeolite used for HC trap layer C can be reduced without lowering HC trapping efficiency.

### EXAMPLES

The present invention is described in more detail by way of examples by referring to the accompanying drawings. However, these examples are only illustrative and not intended to limit a scope of the present invention thereto.

### Example 1

The catalytic converter with the three-layered structure as described in the first embodiment was produced in the following manner. Zeolite layer C, used as the HC trap layer, including a washcoat (hereinafter referred to as WC) was formed on carrier D. An amount of WC was 150 grams per one liter of carrier D (hereinafter referred to as g/L). Inner layer B including 0.6 g/L of Pd, 0.4 g/L of Rh and 100 g/L of WC was formed on zeolite layer C. Outer layer A as the outer-most layer, including 1.8 g/L of Pd and 40 g/L of WC, was formed on inner layer B. Thus, Pd was used for outer layer A and the amount of Pd present therein based on the unit volume of carrier D was larger than the amount of Pd present in inner layer B based on the unit volume of carrier D. The amount of WC present in outer layer A based on the unit volume of carrier D was smaller than the amount of WC present in inner layer B based on the unit volume of carrier D.

The thus-produced catalytic converter was subjected to measurement of temperature variations of zeolite layer C and outer layer A relative to a time elapsed from the engine start-up.

The catalytic converter was then subjected to measurement of a HC purification rate. The HC purification rate used herein represents the ratio of the amount of the HC present in the exhaust gas emitted from the engine for the period before completing the engine warm-up to the total amount of HCs entering the catalytic converter through an inlet thereof and released from zeolite layer C.

### Example 2

The catalytic converter with the three-layered structure was produced in the same manner as described in Example 1, except that a mass ratio of Pd present in outer layer A to WC present therein and a total mass ratio of Pd and Rh present in inner layer B to WC present therein were varied as shown in Table 1. Specifically, the mass ratio of Pd present in outer layer A to WC present therein was 10% and the total mass ratio of Pd and Rh present in inner layer B to WC present therein was approximately 1.8%. Used in outer layer A were 1.4 g/L of Pd and 14 g/L of WC. Used in inner layer B were 1.0 g/L of Pd, 0.4 g/L of Rh and 80 g/L of WC. The mass ratio of Pd present in outer layer A to WC present therein was five times or more the total mass ratio of Pd and Rh present in inner layer B to WC present therein. The thus-produced catalytic converter was subjected to the same measurements as described in Example 1.

### Example 3

The catalytic converter with the three-layered structure was produced in the same manner as described in Example 1, except that outer layer A includes Rh, whose amount present in outer layer A was calculated as a value obtained by multiplying the amount of Rh by ten, so that the amount of Rh present in outer layer A based on the unit volume of carrier D became larger than the amount of Pd present in inner layer B based on the unit volume of carrier D. Used in outer layer A were 1.4 g/L of Rh and 36 g/L of WC. Used in inner layer B were 4.2 g/L of Pd and 60 g/L of WC. The thus-produced catalytic converter was subjected to the same measurements as described in Example 1.

### Example 4

The catalytic converter with the three-layered structure was produced in the same manner as described in Example 1, except that the compositions of outer and inner layers A and B were varied as shown in Table 1. Specifically, 1.5 g/L of Pd and 30 g/L of WC were used in outer layer A, and 1.0 g/L of Pt, 0.3 g/L of Rh and 8 g/L of WC were used in inner layer B. The thus-produced catalytic converter was subjected to the same measurements as described in Example 1.

### Example 5

The catalytic converter with the three-layered structure was produced in the same manner as described in Example 3, except that Ce was used as promoters (co-catalysts) present in outer and inner layers A and B and that an amount of Ce present in outer layer A based on the unit volume of carrier D was smaller than an amount of Ce present in inner layer B based on the unit volume of carrier D. Specifically, 2.0 g/L of Ce as the promoter was used in outer layer A, and 10.0 g/L of Ce as the promoter was used in inner layer B. The thus-produced catalytic converter was subjected to the same measurements as described in Example 1.

### Example 6

The catalytic converter with the three-layered structure was produced in the same manner as described in Example 4, except that Ce was used as a promoter present in outer layer A and Ce and Ba were used as promoters (co-catalysts) inner layer B and that an amount of Ce present in outer layer A based on the amount of carrier D was smaller than a total amount of Ce and Ba present in inner layer B based on the amount of carrier D. Specifically, 2.0 g/L of Ce as the promoter was used in outer layer A, and 1.0 g/L of Ce and 20.0 g/L of Ba as the promoters were used in inner layer B. The thus-produced catalytic converter was subjected to the same measurements as described in Example 1.

### Example 7

The catalytic converter with the four-layered structure as described in the second embodiment was produced as follows. Before the three-layered structure was formed in the same manner as described in Example 2, alumina layer E as a base coat layer was applied onto carrier D and thus disposed between zeolite layer C and carrier D. An amount of WC used in zeolite layer C decreased to 100 g/L, while 150 g/L of WC was used in Example 2. The thus-produced catalytic converter was subjected to the same measurements as described in Example 1.

### Comparative Example 1

The catalytic converter with a dual-layered structure was produced in the following manner. Zeolite layer C was formed on carrier D and single catalyst layer A as the outer-most layer was formed on zeolite layer C. Single catalyst layer A included Pd, Rh and WC. Used in zeolite layer C was 150 g/L. Used in single catalyst layer A were 2.4 g/L of Pd, 0.4 g/L of Rh and 140 g/L of WC. The thus-produced catalytic converter was subjected to the same measurements as described in Example 1.

Table 1 illustrates the compositions of layers A-C used in Examples 1-6, those of layers A-C and E in Example 7 and those of layers A and C in Comparative Example 1.

TABLE 1

| | Composition of Layer | | | |
|---|---|---|---|---|
| Ex- | (gram per one liter Carrier D) | | | |
| am- | Outer Layer | Inner Layer | Zeolite | Alumina |
| ples | A | B | Layer C | Layer E |
| Ex. 1 | Pd 1.8, WC 40 | Pd 0.6, Rh 0.4, | WC 150 | — |
| | | WC 100 | | |
| Ex. 2 | Pd 1.4, WC 14 | Pd 1.0, Rh 0.4, | WC 150 | — |
| | | WC 80 | | |
| Ex. 3 | Rh 1.4, WC 36 | Pd 4.2, WC 60 | WC 150 | — |
| Ex. 4 | Pd 1.5, WC 30 | Pt 1.0, Rh 0.3, | WC 150 | — |
| | | WC 8 | | |
| Ex. 5 | Rh 1.4, WC 36, | Pd 4.2, WC 60 | WC 150 | — |
| | Ce 2.0 | Ce 10.0 | | |
| Ex. 6 | Pd 1.5, WC 30, | Pt 1.0, Rh 0.3, | WC 150 | — |
| | Ce 2.0 | WC 8 | | |
| | | Ce 1.0, Ba 20.0 | | |
| Ex. 7 | Pd. 1.4, WC 14 | Pd. 1.0, Rh 0.4, | WC 100 | WC 50 |
| | | WC 80 | | |
| Com. | Pd 0.6, Rh 0.4, | — | WC 150 | — |
| Ex. 1 | WC 100 | | | |

FIG. 2 illustrates characteristic curves of the catalytic converters in Example 1 and Comparative Example 1, which was obtained by the measurements of the temperature variations of outer catalyst layers A of the catalytic converters in Example 1 and Comparative Example 1 relative to the time elapsed from the engine start-up. In FIG. 2, solid line curves indicate the temperature variation of outer catalyst layer A of the catalytic converter in Example 1 and the temperature variation of single catalyst layer A of the catalytic converter in Comparative Example 1, while broken line curve indicates the temperature variation of zeolite layer C. As shown in FIG. 2, as the time elapsed increases, the temperature of outer catalyst layer A in Example 1, the temperature of single catalyst layer A in Comparative Example 1 and the temperature of zeolite layer C gradually raise up. The temperatures of outer catalyst layer A in Example 1 and single catalyst layer A in Comparative Example 1 which are directly exposed to the exhaust gas, rise at a rate higher than that of the temperature rise of zeolite layer C. When time t1 has been elapsed, zeolite layer C reaches the HC release start temperature at which the HC trapped in zeolite layer C starts to be released therefrom. When time t2 larger than time t1 has been elapsed, single catalyst layer A in Comparative Example 1 reaches the HC purification start temperature at which the catalyst present in single catalyst layer A becomes active to purify the HC. When time t3 disposed between t1 and time t2 has been elapsed, outer catalyst layer A in Example 1 reaches the HC purification start temperature. As seen from FIG. 2, outer catalyst layer A in Example 1 reaches the HC purification start temperature at time t3 remarkably earlier than time t2 for single catalyst layer A in Comparative Example 1. Thus, the catalytic converter in Example 1 can be activated to purify the released HC more quickly than the catalytic converter in Comparative Example 1. On the other hand, the catalytic converter in Comparative Example 1 cannot be activated before time 2 and fails to purify the HC released during the period from time t3 to time t2. The catalytic converters in Examples 2-7 have the characteristics similar to that of the catalytic converter in Example 1 as explained above.

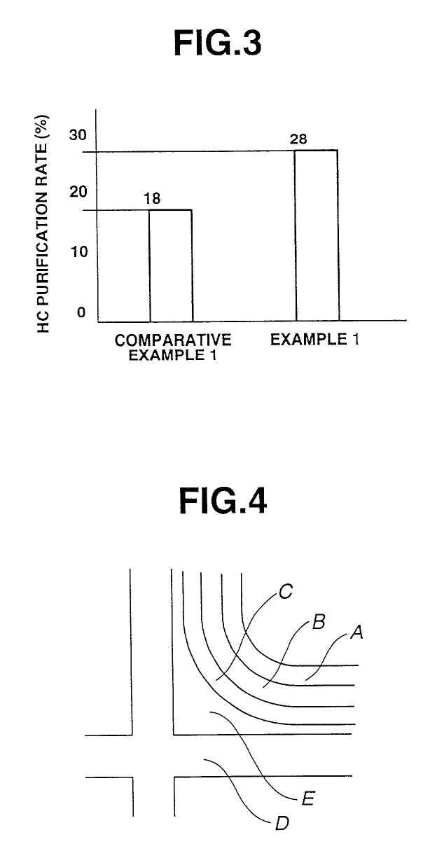

FIG. 3 illustrates the HC purification rates exhibited in the catalytic converters in Example 1 and Comparative Example 1. As seen from FIG. 3, the catalytic converter in Example 1 has the HC purification rate higher than that of the catalytic converter in Comparative Example 1. The catalytic converter in Example 1 is thus improved in the HC purification rate, as compared with the catalytic converter in Comparative Example 1. The catalytic converters in Examples 2-7 have the HC purification rate similar to that of the catalytic converter in Example 1.

This application is based on Japanese Patent Application No. 11-370145, filed on Dec. 27, 1999, the entire contents of which, inclusive of the specification, claims and drawings, are hereby incorporated by reference herein.

Although the invention has been described above by reference to certain embodiments and examples of the invention, the invention is not limited to the embodiments and examples described above. Modifications and variations of the embodiments and examples described above will occur to those skilled in the art, in light of the above teachings. The scope of the invention is defined with reference to the following claims.

What is claimed is:

1. A catalytic converter, comprising:
a carrier;
a hydrocarbon (HC) trap layer trapping HC, said HC trap layer being disposed on the carrier; and
at least two catalyst layers comprising an inner layer disposed on the HC trap layer and an outer layer disposed on the inner layer, said inner and outer layers comprising catalyst noble metals,
an amount of said catalyst noble metal present in the outer layer based on a unit volume of the carrier being larger than an amount of the catalyst noble metal present in the inner layer based on the unit volume of the carrier.

2. A catalytic converter as claimed in claim 1, wherein the catalyst noble metals comprise rhodium, an amount of the rhodium being calculated as a value obtained by multiplying the amount of the rhodium by a predetermined number.

3. A catalytic converter as claimed in claim 2, wherein the predetermined number is defined depending on the kind of the catalyst noble metals other than rhodium.

4. A catalytic converter as claimed in claim 2, wherein the outer layer comprising the rhodium is an outer-most layer.

5. A catalytic converter, comprising:
a hydrocarbon (HC) trap layer trapping HC; and
at least two catalyst layers comprising an inner layer disposed on the HC trap layer and an outer layer disposed on the inner layer, each of said inner and outer layers comprising a catalyst noble metal and a washcoat,
a mass ratio of said catalyst noble metal present in the outer layer to the washcoat present therein being higher than a mass ratio of the catalyst noble metal present in the inner layer to the washcoat present therein.

6. A catalytic converter as claimed in claim 5, wherein the outer layer is an outer-most layer, a mass ratio of the catalyst noble metal present in said outer-most layer to the washcoat present therein being five times or more a mass ratio of the catalyst noble metal present in the inner layer below the outer-most layer to the washcoat present therein.

7. A catalytic converter, comprising:
a carrier;
a hydrocarbon (HC) trap layer trapping HC, said HC trap layer being disposed on the carrier; and
at least two catalyst layers comprising an inner layer disposed on the HC trap layer and an outer layer disposed on the inner layer, each of said inner and outer layers comprising a catalyst noble metal and a washcoat,
an amount of said washcoat present in the outer layer based on a unit volume of the carrier being smaller than an amount of the washcoat present in the inner layer based on the unit volume of the carrier.

8. A catalytic converter as claimed in claim 1, wherein the outer layer is an outer-most layer, said outer-most layer comprising palladium, said inner layer disposed below the outer-most layer comprising a combination selected from palladium, platinum and rhodium.

9. A catalytic converter as claimed in claim 2, wherein the outer layer is an outer-most layer, said outer-most layer comprising palladium, said inner layer disposed below the outer-most layer comprising a combination selected from palladium, platinum and rhodium.

10. A catalytic converter as claimed in claim 5, wherein the outer layer is an outer-most layer, said outer-most layer comprising palladium, said inner layer disposed below the outer-most layer comprising a combination selected from palladium, platinum and rhodium.

11. A catalytic converter as claimed in claim 6, wherein the outer-most layer comprises palladium, said inner layer disposed below the outer-most layer comprising a combination selected from palladium, platinum and rhodium.

12. A catalytic converter as claimed in claim 7, wherein the outer layer is an outer-most layer, said outer-most layer comprising palladium, said inner layer disposed below the outer-most layer comprising a combination selected from palladium, platinum and rhodium.

13. A catalytic converter as claimed in claim 1, wherein the inner and outer layers comprise promoters, respectively, an amount of said promoter present in the outer layer based on the unit volume of the carrier being smaller than an amount of said promoter present in the inner layer based on the unit volume of the carrier.

14. A catalytic converter as claimed in claim 2, wherein the inner and outer layers comprise promoters, respectively, an amount of said promoter present in the outer layer based on the unit volume of the carrier being smaller than an amount of said promoter present in the inner layer based on the unit volume of the carrier.

15. A catalytic converter as claimed in claim 5, further comprising a carrier supporting the HC trap layer, said inner and outer layers comprising promoters, respectively, an amount of said promoter present in the outer layer based on the unit volume of the carrier being smaller than an amount of said promoter present in the inner layer based on the unit volume of the carrier.

16. A catalytic converter as claimed in claim 6, further comprising a carrier supporting the HC trap layer, said inner and outer layers comprising promoters, respectively, an amount of said promoter present in the outer layer based on the unit volume of the carrier being smaller than an amount of said promoter present in the inner layer based on the unit volume of the carrier.

17. A catalytic converter as claimed in claim 7, wherein said inner and outer layers comprising promoters, respectively, an amount of said promoter present in the outer layer based on the unit volume of the carrier being smaller than an amount of said promoter present in the inner layer based on the unit volume of the carrier.

18. A catalytic converter as claimed in claim 8, wherein said inner and outer layers comprising promoters, respectively, an amount of said promoter present in the outer layer based on the unit volume of the carrier being smaller than an amount of said promoter present in the inner layer based on the unit volume of the carrier.

19. A catalytic converter as claimed in claim 1, further comprising a base coat layer disposed between the carrier and the HC trap layer, said base coat layer comprising one of alumina and silica as a main component.

20. A catalytic converter as claimed in claim 2, further comprising a base coat layer disposed between the carrier and the HC trap layer, said base coat layer comprising one of alumina and silica as a main component.

21. A catalytic converter as claimed in claim 5, further comprising a base coat layer disposed between the carrier and the HC trap layer, said base coat layer comprising one of alumina and silica as a main component.

22. A catalytic converter as claimed in claim 6, further comprising a base coat layer disposed between the carrier and the HC trap layer, said base coat layer comprising one of alumina and silica as a main component.

23. A catalytic converter as claimed in claim 7, further comprising a base coat layer disposed between the carrier and the HC trap layer, said base coat layer comprising one of alumina and silica as a main component.

24. A catalytic converter as claimed in claim 8, further comprising a base coat layer disposed between the carrier and the HC trap layer, said base coat layer comprising one of alumina and silica as a main component.

25. A catalytic converter, comprising:
a carrier;
a hydrocarbon (HC) trap layer trapping HC, said HC trap layer being disposed on the carrier; and
a multilayered catalyst system disposed on the HC trap layer, said multilayered catalyst system comprising a first catalyst layer disposed on the HC trap layer and a second catalyst layer disposed on the first catalyst layer, said first and second catalyst layers comprising catalyst noble metals, respectively, said catalyst noble metal present in the second catalyst layer being controlled to be active earlier than the catalyst noble metal present in the first catalyst layer.

26. A catalytic converter as claimed in claim 25, wherein an amount of the catalyst noble metal present in the second catalyst layer based on a unit volume of the carrier is larger than an amount of the catalyst noble metal present in the first catalyst layer based on the unit volume of the carrier.

27. A catalytic converter as claimed in claim 25, wherein the first and second catalyst layers comprise washcoats, respectively, a mass ratio of said catalyst noble metal present in the second catalyst layer to the washcoat present therein being higher than a mass ratio of the catalyst noble metal present in the first catalyst layer to the washcoat present therein.

28. A catalytic converter as claimed in claim 26, wherein the catalyst noble metal present in the second catalyst layer comprises rhodium, an amount of said rhodium being calculated as a value obtained by multiplying the amount of the rhodium by a predetermined number.

29. A catalytic converter as claimed in claim 28, wherein the predetermined number is defined depending on the kind of the catalyst noble metals other than rhodium.

30. A catalytic converter as claimed in claim 25, wherein the first and second catalyst layers comprise washcoats, respectively, an amount of said washcoat present in the second catalyst layer based on a unit volume of the carrier being smaller than an amount of the washcoat present in the first catalyst layer based on the unit volume of the carrier.

31. A catalytic converter as claimed in claim 25, wherein the first and second catalyst layers comprise promoters, respectively, an amount of said promoter present in the second catalyst layer based on a unit volume of the carrier being smaller than an amount of the promoter present in the first catalyst layer based on the unit volume of the carrier.

32. A catalytic converter as claimed in claim 25, further comprising a base coat layer disposed between the carrier and the HC trap layer, said base coat layer comprising one of alumina and silica as a main component.
